(19) United States
(12) Patent Application Publication
(10) Pub. No.: US 2021/0034709 A1
(43) Pub. Date: Feb. 4, 2021

(54) OPTIMIZING INCREMENTAL BACKUPS

(71) Applicant: EMC Corporation, Hopkinton, MA (US)

(72) Inventors: Kedar S. Patwardhan, Pune (IN); Suraj M. Multani, Bangalore (IN)

(73) Assignee: EMC Corporation, Hopkinton, MA (US)

(21) Appl. No.: 14/042,252

(22) Filed: Sep. 30, 2013

(51) Int. Cl. G06F 17/30

(52) U.S. Cl. CPC G06F 17/30129

(57) ABSTRACT

Systems and method for performing backup. A layered file system is provided that is configured to detect all transactions with a physical file system. Based on an analysis of the transactions, records are selectively entered into a change log. A backup agent is able to generate a backup based on the change log, which reflects data that has changed or that needs to be backed up relative to the previous backup.

### BACKGROUND

One of the many benefits of computers and computing systems is their ability to process data and to make the data useful and readily available. People want immediate access to their email, for example, and email providers implement computing systems with sufficient processing power to handle email related processing. Data is important in other contexts as well. Businesses rely on readily available data to manage product and inventories. Businesses use data, for example, to set prices, sell tickets, or manage schedules. If a business does not have access to their data, the business suffers.

The inability to access data in the short term is often annoying and inconvenient. The complete loss of data, however, can have serious consequences. As a result, it is advisable to backup data. Most businesses and enterprises today have an active backup application that is protecting their data.

There are different types of backup systems in use today. It has long been recognized that repeatedly performing a full backup of data can consume significant space—especially when the backups are retained over time. In an incremental backup system, for instance, the amount of data backed up is reduced because an incremental backup only backs up modifications or changes that have been made to the data since the last backup.

While this approach can minimize the amount of data that is backed up at a given time, incremental backups also have undesirable features. For example, identifying which data (e.g., which files) have changed since the last backup may require that all of the files be examined to analyze the modification time stamps. For larger systems, which may have millions of files, this can become a time consuming process and can degrade the computing performance.

More generally, conventional backup applications that support incremental backups trawl the entire file system to generate a list of modified files. This can consume significant resources as previously stated.

Instead of trawling the entire file system, some backup applications may take advantage of the file system's native change log. However, using the native change log can also result in degraded performance. This is partly related to the fact that conventional change logs are transactional in nature. Every change that occurs to a file is recorded in a conventional change log. For example, a change log may record that a particular file is created, changed a large number of times, and then deleted.

Because a transactional change log records transactions for all files in a temporal manner, the transactions associated with a particular file will be interspersed with changes to other files. During backup, all of these changes need to be processed even though the file is ultimately deleted. Consequently, the activity associated with performing a backup based on a transactional change log can also degrade the performance of the file system.

### BRIEF DESCRIPTION OF THE DRAWINGS

In order to describe the manner in which at least some of the advantages and features of the invention can be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 illustrates an example of a system in which a backup operation is performed;

FIG. 2 illustrates an example of a system or environment that includes a layered file system that processes transactions in the system in order to prepare for a subsequent backup;

FIG. 3 illustrates an example of backups that may be stored in a system;

FIG. 4 illustrates an example of a method for performing a backup of data; and

FIG. 5 illustrates another example of a method for performing a backup of data.

### DETAILED DESCRIPTION

Embodiments of the invention relate to systems and methods and computer-readable media for backing up data or for performing backup operations. Embodiments of the invention further relate to incremental backups or to forever incremental backup systems. When performing an incremental backup, only changes that have occurred to the data since the last backup are included in the incremental backup. Embodiments of the invention can optimize the process of performing an incremental backup and/or of preparing for an incremental backup such that the need to trawl the file system is reduced or eliminated.

In one example, a layered file system (a layered file driver) is inserted into a computing environment. The layered file system may be inserted between a virtual file system or operating system and a physical file system. In some systems, a layered file system may be instantiated for each client or for each device or each file system or physical file system. The configuration may be dependent on how the computing system is organized and/or on how the physical file system is organized relative to the operating systems and user applications.

Placing the layered file system above the physical file system enables the layered file system to identify all changes made to any/all files in a file system. The layered file system is positioned to evaluate every transaction that occurs with respect to the physical file system. The layered file system can also identify changes to the file system itself, such as changes in the size of the file system.

The layered file system can evaluate the transactions and then selectively record some of the transactions or information related to some of the transactions in a change log. As a result, the layered file system does not typically record or keep all transactions that occur in the computing environment. In one embodiment, the layered file system only maintains a record of transactions that have an impact on a subsequent backup operation. The layered file system, however, can be configured to record other transactions. Advantageously, the layered file system begins to prepare the environment or system for the next backup operation and is able to reduce overhead associated with at least incremental backup operations. By selectively recording entries in a change log that relate to transactions with the files or data stored in the physical file system, embodiments enable a backup agent to rely on the change log when the next backup operation is performed. In some examples, more than one change log may be maintained. For example, when a backup operation is initiated, subsequent transactions may be recorded in a different change log to ensure that the next incremental backup is not mixed with the current incremental backup. The switch can be performed immediately or gradually. In either case, the change logs are configured and interpreted such that the incremental backups are consistent and minimized in size.

When a backup such as an incremental backup is then performed, the incremental backup can be based on the change log that has been prepared by the layered file system. This optimizes the incremental backup and reduces the impact of performing the backup on overall system performance.

Embodiments of the invention can be implemented in multiple hardware configurations and/or network configurations.

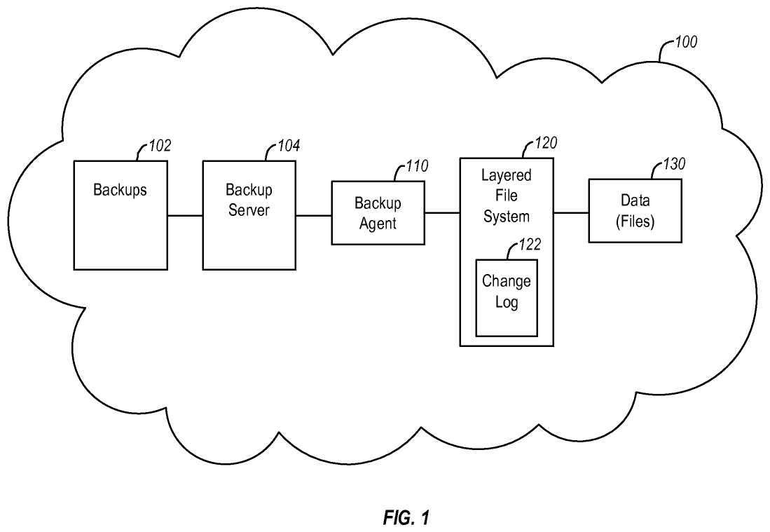

FIG. 1 illustrates an example of a system in which a backup operation is performed. FIG. 1 illustrates that a backup of data 130 may occur within a network 100. The network 100 can be a local area network, a wide area network, or other type of network. Each of the components or modules illustrated in the network 100 may also include hardware components or modules such as processors, memory, network adapters or the like. The communication between components or modules may occur over wired or wireless connections using appropriate protocols.

FIG. 1 illustrates a backup server 104 that cooperates with a backup agent 110 to perform backups of the data 130 (also referred to herein as files 130). The data may be associated with a client and may be stored on a storage device or on multiple storage devices. The data or files may be associated with a file system, a server such as a file server or an email server, a database, one or more volumes, or the like. The backup agent 110 typically operates on or has access to the client being backed up and or the data 130. The following discussion refers to the data 130 as files, but one of skill in the art can appreciate that the data may take other forms such as emails, database entries, or the like or combination thereof. The various data types may be referred to as data or files.

The backup agent 110 can coordinate with the backup server 104 to ensure that the data or files 130 being backed up are sent to the backup server 104 and included in the backups 102. In one example, the backup server 104 maintains or manages the backups 102 for one or more clients. In other words, the backups 102 can include backups for different data or different sets of files or different file systems. The backups 102 may include backups of a file system, backups of an email system or server, backups of a database, or the like. For ease of discussion, the various forms of data of a database, email server, or the accompanying storage or the like may be referred to generally as file systems.

The backups 102 can include a full backup of the files 130 (or other data or client) and one or more subsequent incremental backups of the files 130. When a restoration is required, the client can be restored using the appropriate backups selected from all of the backups 102. The files 130 can be restored at various points in time because multiple incremental backups are kept in one example.

In FIG. 1, the backup agent 110 may communicate or cooperate with a layered file system 120 to identify the files 130 to be backed up. In one example, the incremental backup may only include portions of the files 130. In one example, only files 130 that have changed since the last backup are backed up and included in the subsequent incremental backup.

The information identifying which files 130 or portions thereof have changed may be maintained in a change log 122. The layered file system 120 can trap or evaluate all transactions (e.g., all file system operations or all client operations on the files 130) and then selectively record these operations (or information identifying the files to be backed up) in the change log 122. As a result, the change log 122 effectively identifies the files that needs to be backed up and the backup agent does not need to trawl the files 130 and does not need to deal with all of the transactions that have occurred to the files 130 since the last backup.

Instead, the change log 122 simply identifies that a certain file or portion thereof should be included in the next backup regardless of other transactions that may have occurred relative to that same file since the most recent backup. The layered file system 120 can selectively enter records in the change log 122 such that changes relevant to the next backup are included in the change log 122. Other changes that are not relevant to the next backup can be kept from the change log 122. The backup, which may be an incremental backup, is then created and stored in the backups 102.

Examples of transactions that are trapped or evaluated by the layered file system include, but are not limited to, writes, truncates, deletes, creates, appends, attribute changes, or the like or any combination thereof (generally referred to as modifications). In addition, the transactions trapped or evaluated by the layered file system may also include changes to the file system itself. For example, the transactions may include or reference changes like growth or shrinkage of the file system.

The transactions can be analyzed and then selectively recorded in the change log 122. The analysis of the transaction may involve a comparison between attributes of the files referenced in the transactions and attributes of the files already present in the file system. The analysis may also account for the file's status, such as whether the file was present in the file system at the time of the last backup. Based on the evaluation performed by the layered file system, the transaction may or may not be recorded in the change log 122. The process of performing an incremental backup is advantageously optimized by the selective content of the change log 122.

The change log may include records for each file in the file system. The records in the change log may be indexed, in one example, by an inode number of the corresponding files. A record in the change log 122 may include multiple fields or sections including, but not limited to, an old file name, a new file name, an event mask, a last backup file size, an inode number, or the like or any combination thereof.

When an transaction is evaluated, the transaction could be reflected in the corresponding record for the inode of the file involved in the transaction. An example of a record is as follows:

Old File Name: /mnt1/dir1/file1

New File Name: /mnt1/dir3/fi1e4

Event Mask: DELETE | CREATE| SETATTR

Last Backup Size: 0

inode number: 0×34fd

This record contains the entire history (or portion thereof) of an inode in a single record. The history may be limited to the time since the most recent backup. Analyzing this record enables the backup agent to determine how the file should be handled during the backup operation. This record indicates that the inode was removed, which is reflected by the DELETE event mask. The old name was stored in the old file name field. The inode was later used for a new file and the new file name is stored in the new file name field. This transaction is reflected by the CREATE event mask in the event mask field. Later, the owner and permissions of the file were changed, which resulted in the SETATTR entry in the event mask field. The last backup size is zero because the file is new at least with respect to a most recent backup.

When performing the backup operation, this information enables the file corresponding to the record to be backup up appropriately without having to trawl the file system. Had the last entry in the event mask field been DELE IL, then the backup agent would know that the file has been removed and there is no need to search for the file. A conventional change log, however, would result in a disk access request for a file that does not exist because all transaction for the inode are not grouped together.

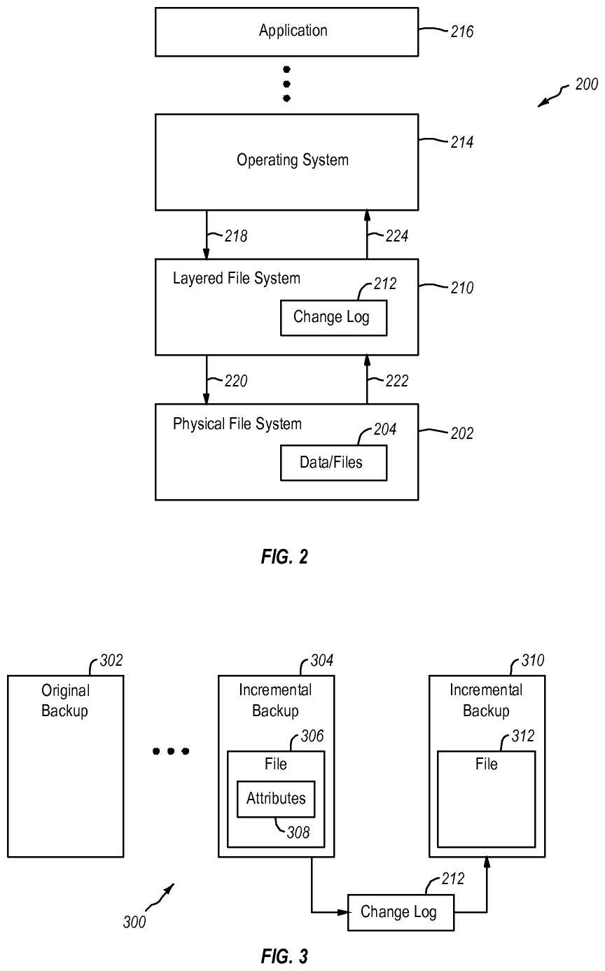

FIG. 2 illustrates an example of a computing system or environment that includes a layered file system that processes or evaluates transactions in the computing system in order to prepare the system for an upcoming backup operation. FIG. 2 illustrates a stack 200 that illustrates an example of a system architecture. One of skill in the art can appreciate that the stack 200 may have other components. For example, a volume manage, a disk driver, and an MPIO may be below the physical file system and a virtual file system may be above the layered file system. However, FIG. 2 illustrates that the layered file system 210 is placed such that file events or transactions can be evaluated in a manner than enables the change log 212 to be used for a backup operation.

In FIG. 2, an application 216 (e.g., a word processing application, a database, an email server) may operate on an operating system 214. The operating system 214 may alternatively be a virtual machine or a virtualized system. The operating system 214 (or virtual machine) sits on a physical file system 202. The physical file system 202 may include storage devices capable of storing data 204 or files. The storage devices can be arranged as multiple disks, network attached storage, storage arrays, or the like or any combination thereof.

In this example, a layered file system 210 is inserted between or operates between the operating system 214 and the physical file system 202. Placing the layered file system 210 at this level enables the layered file system 210 to trap or evaluate all of the transactions 218 that are sent to the physical file system as transactions 220. The layered file system 210 may simply pass through the transactions 218 unchanged and without detaining the transactions. Similar, transactions 222 originating from the physical file system may also be trapped or analyzed by the layered file system 210 and are passed unaltered to the operating system as transactions 224. In one example, the layered file system 210 may be transparent to the operating system 214.

The layered file system 210, which is an example of the layered file system 120, evaluates or analyzes the transactions 218 and/or the transactions 222 to determine whether an entry needs to be made in the change log 212, which is an example of the change log 122. The change log 212 may be a representation of all of the transactions 218 and/or 222 that have occurred since the last backup and that need to be accounted for in the next backup. Once a backup is completed, the change log 212 may be cleared of existing entries in one example, or certain information may be retained in the change log 212 from one backup to the next backup.

In one example, when a backup operation is initiated, the layered file system 210 may switch to a different change log in one example. Over time, the change logs can be purges as necessary and reused. By switching to a new change log, however, the files to be included in the next backup operation are identified in the new change log. Alternatively, the same change log can be used and the backup agent is configured to distinguish between entries that were part of previous backup operations and entries that should be processed for the next backup operation.

The layered file system 210 is configured to make entries in the change log 212 so that it is not necessary for a backup agent to trawl the data or files 204 and so that the backup agent does not need to worry about all of the transactions that may have occurred since the last backup. The change log 212 may be an optimized representation of the transactions 218 or 222 that have occurred in a given time period or since the last backup. The change log 212 may include enough information to enable a backup agent to retrieve the files or portions of files that should be included in the next backup.

FIG. 3 illustrates an example of backups 300 that may be stored in a computing system (e.g., an enterprise computing network). The backups 300 may be an example of a forever incremental backup or of another system that incorporates incremental backups. FIG. 3 illustrates an original backup 302 of data (e.g., a file system, a client, a server, one or more volumes, or other data or the like). The backup 302 may be a full backup of certain data.

Over time, additional incremental backups are performed at some interval. This sequence of incremental backups are stored in the backups. The most recent incremental backup 304 is illustrated in FIG. 3. The incremental backup 304 may include changes to files 306 that have occurred since the incremental backup prior to the incremental backup 304. When a new incremental backup 310 is created, the change log 212, which may identify changes or modifications to files since the most recent incremental backup 304, is used to generate the new incremental backup 310. In this example, the incremental backup includes files 312 or other data. Because the backups 304 and 310 are incremental backups, the files 306 are likely different from the files 312. More specifically, the makeup of the files 312 included in each of the incremental backups (e.g., the incremental backups 304 and 310) depends on the transactions that occurred in the file system and on the transactions recorded in the change log 212.

Because the layered file system 210 makes selective entries in the change log 212, the size of the change log 212 is smaller and can be handled more efficiently than a pure conventional transaction change log. As previously stated, performing an incremental backup based on a conventional transactional change log can significantly reduce system performance for various reasons. A change log that only includes certain entries may not reflect a transactional history, but the change log may be optimized for performing backup operations including incremental backup operations.

The layered file system 210 evaluates transactions related to files (or other data) in the physical file system. The analysis may rely on attributes 308 of files in a previous backup, on attributes of files as currently stored in the file system, or the like or any combination thereof. The following discussion describes some of the analysis that is performed by the layered file system when deciding whether to make an entry in the change log 212.

The analysis performed by the layered file system begins when a transaction is identified. An identified transaction can be trapped, copied, queued or the like. In one example, the transaction may simply be queued and the analysis is performed on the transaction without pausing the transaction itself. This allows the file system to operate normally while still allowing the layered file system to determine whether the transaction or other information should be entered into the change log. In one example, the transaction is copied temporarily in order to perform the analysis on the transaction.

For example, a transaction occurs when a file is created. When the file is created after the last backup, this transaction only needs to be recorded a single time in the change log 212. Subsequent writes to the newly created file do not need to be recorded in the change log because the file, however it exists at the time of the next backup, will be included in the next backup. Thus, a file that is created after the last backup should be recorded only once in the change log 212 in one example. The record may therefore include a CREATE entry in the event mask. Writes to such a newly created file (since the last backup) need not be recorded in the change log 212 since all contents of the file are new at least with respect to the last backup. A transaction other than a write, such as a DELETE or SETATTR, may be reflected in the record in the change log 212 for the file.

When the file is newly created, the layered file system 210 should create a record denoting the creation of the file but flush the record to the change log 212 in a delayed fashion after the last close on the file has been detected. In this example, the entries to the records in the change log may be delayed.

Transactions also occur when a file is written, truncated, or when a set-attribute operation is performed. If a file in the physical file system has experienced a write/truncate/set-attribute operation, the layered file system should first check to determine if the create time of the file is after the most recent backup time If the create time is after the most recent backup time, then the write/truncate/set-attribute operation should not be recorded in the change log 212.

This is an example of selectively recording a transaction or of selectively making an entry in the records included in the change log 212. This also demonstrates that the change log may only identify, in one embodiment, changes that need to be accounted for in the next backup. When a file is newly created, the backup operation can be optimized by noting that the file needs to be backed up without worrying about changes that occur (e.g., writes, truncates) prior to the next backup operation. Operations that happen to a file that is created after the last backup do not need to be recorded in the change log 212 at least in the context of incremental backups. This information could be recorded in another log (e.g., a transactional log), however, if desired.

When a transaction is detected or trapped that relates to the removal or deletion of a file from the file system, the layered file system should first check the creation time of the file being removed by the transaction. If the creation time is after the last backup time, the removal of the file and the creation record associated with the file do not need to be recorded in the change log 212. In other words, the transactions related to the creation and removal of the file can be skipped as long as the change log does not include an entry reflecting the creation of the file. If the creation transaction has been flushed to the change log 212, then the removal transaction should also be reflected in the change log 212 by removing the creation record in one example or by adding a DELETE entry in the event mask. Advantageously, the entries or records in the change log 212 are minimized and the ability to perform an incremental backup is enhanced. In either case, the record can be processed and enable the backup agent to know that the file has been removed and does not need to be backed up.

This discussion also illustrates that the entries in the change log 212 may be entered by the layered file system on a delayed basis. The layered file system, for example, may periodically flush entries to the change log or may flush entries on detecting certain events (e.g., flush a creation record to the change log 212 when a close transaction is detected for the newly created file). This enables the layered file system to wait a certain period of time or until a certain transaction has been detected before making the entry in the change log.

In another example, a transaction may occur where a file that was present during last backup is appended to. In this instance, the layered file system should record a size of the file (last_backup_file_size) during the last backup in the change log 212. No record for appending writes should be maintained in the change log 212 in one embodiment. When the backup is performed, the backup agent should copy all file data in the file past “last_backup_file_size”. This eliminates the need to create change records in the change log 212 for all appending writes made to the file. In this example, a portion of the file is included in the incremental backup since all file data up to the last_backup_file_size was included in the previous backup.

In another example, a transaction in the file system may be related to a file truncation. When a file that was present during last backup is truncated, the layered file system should check to determine if the new size of the file is less than the size of the file at the time of the previous backup. If the size of the file is less, the new file size should be recorded in the change log 212. All writes past this new size (the truncated size) should now be treated as appending writes and handled as described above in the change log 212.

In another example, a transaction may involve changing or altering a time stamp or other attribute of a file. When a time stamp of the file is modified (e.g. using the setattr( ) or other system calls), the layered file system should synchronously record this change along with the inode number of the file and a “generation number” to the change log 212. Subsequently, if the file is removed or deleted, it is possible that the file removal record will be absent from the change log 212 especially if the setattr( )call advanced the creation time of the file since the last backup time (this is due to the optimization previously discussed that files created and removed since the last backup are not recorded in the change log).

If such a file (wherein the time stamp has been modified) were to be written to, no write records would be present in the change log 212 since the creation time has been modified and is after the last backup time. To solve this type of issue, the backup agent may be configured to handle transactions associated with the setattr( ) call or other system calls or attribute changes differently. When reading a setattr( ) record or entry from the change log 212, the backup agent should check for the file's existence at the time of doing the backup. If the file exists, then the backup agent should compare the file's generation number with the generation number recorded with the setattr( ) change log record. If the generation numbers match, then the file will be backed up with all its data since it is not possible to detect whether the file was written to after the setattr( ) call was performed. If the file exists, but the generation number does not match, then the file is assumed to be a new file that was created (with the same name) after the original file was removed. The backup agent in this scenario may replace the previous version of the file with the new version. If, however, the file as recorded in the setattr( ) change log record does not exist, the backup agent may remove the file from the previous backup.

In a transaction that involves a write that is an in-file write (which is different from an appending write in one instance), the regions of the file that have been modified may be tracked. This enables the backup operation to backup the in-line portions of the file that were modified. Alternatively, the entire file is backed up when the write is an in-line write. An appropriate entry may be made in the record of the file in the change log for such a write that allows the backup agent to identify the appropriate regions to include in the backup or that cause the entire file to be backed up.

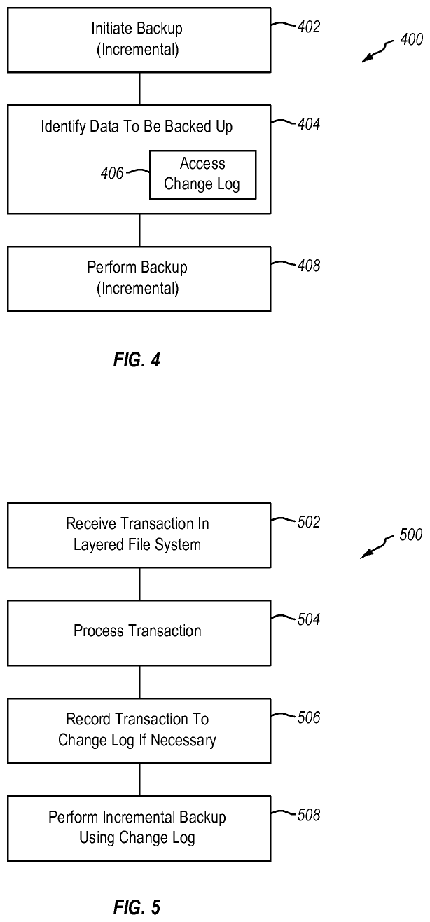

FIG. 4 illustrates an example method for performing a backup of data. The method 400 may begin when a backup is initiated in block 402 (initiate backup). The backup initiated in block 402 may be an incremental backup or another backup. In one example, previous incremental backups have been generated and the present backup is based on differences or changes or modifications with respect to the most recent backup.

The backup operation may be initiated by the backup server, the backup agent, a user, or the like. In block 404 (identify data to be backed up), the data to be backed up is identified or accessed. In one example, the data is identified by accessing the change log in block 406 (access change log).

Accessing the change log may include using the records recorded in the change log to identify which files and/or which parts of files should be included in the backup. The records in the change log may refer to newly created files, appended portions of files, files whose attributes have been modified, or the like or any combination thereof. The backup may also remove files from previous backups where appropriate.

In block 408 (perform backup), the backup is performed. The backup agent can cooperate with the backup server to backup the files that correspond to the records in the change log. The backup agent may access, read, or otherwise process the records in the change log to identify the files and/or portions of files to be backed up.

The change log may store certain attributes about each file to be backed up. The change log, in addition to fields previously discussed, may also store creation date, size, name, and other attributes, or the like or any combination thereof.

FIG. 5 illustrates a method for performing a backup of files (or other data). The method 500 starts by receiving or detecting a transaction in the layered file system in block 502 (receive transaction in layered file system). The transaction may be received because the layered file system is between the operating system (or virtual system) and the physical file system. A transaction may be received by trapping the transaction, copying the transaction, monitoring the transaction, detecting the transaction, or the like. In another example, the transactions are intercepted by the layered file system such that the transactions can be analyzed.

Once a transaction is detected or trapped, the transaction is processed in block 504 (process transaction), for example by the layered file system. Processing the transaction can include one or more acts or steps that are configured to determine whether a record should be made, removed, or updated in the change log. For example, a transaction that involves the creation of a file may involve a comparison between the creation date of the file and the time of the most recent backup. In this case, the layered file system may make an entry or record in the change log that reflects the creation of the file and that causes the backup agent to backup the newly created file in the next backup.

In one example, the layered file system may wait to flush the record of the transaction to the change log until a transaction is detected that closes the file or for a certain amount of time. By waiting to flush records or entries to the change log, it may be possible to eliminate unnecessary records from the change log that relate to transactions that do not impact the files included in the next backup.

When processing the transaction, the decision to create or update a record or entry in the change log is made. In this context, entries in the change log are selectively made. Records of some transactions may be entered into the change log while records of other transactions are not entered in the change log. A newly created file may result in a record in the change log while a transaction that appends data to the file may not result in a record being added to the change log.

In block 506 (record transaction to change log if necessary), the transaction is selectively recorded in the change log. Stated another way, a record of the transaction or that reflects the transaction is entered into the change log. The transaction is recorded in the change log, in one example, only when the transaction results in data that should be included in or accounted for by the next backup. A new file, file amendments or size increases, file truncations, file deletions, and the like are transactions that should be accounted for in the next backup and that may have corresponding entries in the records in the change log.

In block 508 (perform incremental backup using change log), a backup is performed based on the change log. A backup agent may access or use the change log to ensure that the appropriate files or data are backed up in the backup being performed. Embodiments of the invention advantageously reduce the overhead associated with conventional systems that trawls the system to identify changes to include in the incremental backup. In contrast to conventional systems, the change log is generated during normal use of the file system in one example. In addition, inefficiencies associated with transactional change logs are reduced because entries in the change log of the present disclosure are entered in a selective manner.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ can refer to software objects or routines that execute on the computing system. The different components, modules, engines, and services described herein may be implemented as objects or processes that execute on the computing system, for example, as separate threads. While the system and methods described herein can be implemented in software, implementations in hardware or a combination of software and hardware are also possible and contemplated. In the present disclosure, a ‘computing entity’ may be any computing system as previously defined herein, or any module or combination of modulates running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention can be performed in client-server environments, whether network or local environments, or in any other suitable environment. Suitable operating environments for at least some embodiments of the invention include cloud computing environments where one or more of a client, server, or target virtual machine may reside and operate in a cloud environment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method for backing up data in a system, the method comprising:
identifying data stored in a physical file system to be backed up, the data including files;
intercepting transactions, by a layered file system, to the stored in physical file system that occur in the system, the transactions including transactions related to changes to the physical file system including writes;
recording the transactions as records in a change log;
optimizing the records when recording the transactions by selectively recording the transactions in the change log,
wherein the records related to transactions that result in changes to the data or the physical file system are stored in the change log, wherein the records stored in the change log identify at least which blocks in the physical file system were changed by the intercepted transactions,
wherein the records are configured to prevent disk accesses for files that do not need to be backed up even when changes occurred to those files and when those files are subject to the backup of the data,
wherein a transaction to create a file occurs after a most recent backup is stored in the records and is included in the change log and wherein transactions including writes to the created file that result in changes to the file that was created after a most recent backup are not stored in the records and are not included in the change log;
initiating a backup of the data to backup changes in the data that have occurred since a previous backup;
accessing the change log to identify the specific data corresponding to the records in the change log; and
backing up the specific data based on the records for the specific data in the change log from the physical file system.

2. The method of claim 1, further comprising backing up the specific data in an incremental backup.

3. The method of claim 1, further comprising entering the records into the change log.

4. The method of claim 3, further comprising flushing the records into the change log after a delay or after another specific transaction is intercepted.

5. The method of claim 1, further comprising analyzing the transactions to determine which transactions should result in a record in the change log.

6. The method of claim 5, wherein analyzing the transactions includes one or more of:
when the transaction for the data is a create transaction, entering the record for the transaction in the change log when a create time of the data is after a time of the most recent backup;
when the transaction is a write, a truncate or a system call operation, checking if a create time of the data is after a time of the most recent backup, wherein the record for the transaction is not entered in the change log when the create time of the data is after the time of the most recent backup;
when the data is removed, checking the create time of the data, wherein the record is not entered in the change log as long as a create record of the data has not been recorded in the change log;
when the data is being appended to existing data, recording a size of the existing data during the most recent backup in the change log;
when data is being truncated, check if a new size of the data is less than the size of the data at the time of the most recent backup, wherein the new file size is recorded in the change log when the new size is less than the size, wherein subsequent writes to the data are treated as begin appended; and
when a time stamp of the data is modified, recording the change to the time stamp and an inode number of the data and a generation number of the data.

7. The method of claim 6, wherein when the time stamp of the data is modified, a backup agent checks for the existence of the data at the time of performing the backup, wherein the backup agent compares the generation number with a previously recorded generation number, wherein the file is backed up when the generation numbers match.

8. A method for backing up files in a file system, the method comprising:
receiving a transaction in a layered file system;
evaluating the transaction to determine whether a record for the transaction should be entered into a change log such that transactions entered into the change log are optimized, wherein the change log is optimized by determining that only records related to transactions needed to perform a next backup operation are stored in the change log wherein the records are configured to prevent disk accesses for files that do not need to be backed up even when changes occurred to those files and when those files are subject to the backup of the data;
recording a record in the change log for the transaction if the file or a portion of the file associated with the transaction should be backed up in a next backup based on the evaluation of the transaction, wherein the record identifies which blocks in the layered file system to include in the next backup, wherein the record includes an event mask configured such that multiple transactions may be included in the same record for the same data, wherein the record in the change log includes a transaction for a file that was created after a most recent backup and wherein the record for write transactions to the created file are not recorded in the change log when the transactions correspond to writes to the created file that was created after the most recent backup;
performing an incremental backup of the files in the file system based on the records in the change log from the layered file system, wherein all of the multiple transactions in the same record for the same data are considered when evaluating the record when determining whether the blocks identified in the record should be included in the incremental backup or should not be included in the backup, wherein all transactions in each of the records, which transactions occur at different times, are considered when the record is processed, and
flushing records associated with transactions received by the layered file system to the change log, wherein records related to transactions where only attributes of the files are affected are synchronously stored in the change log by the layered file system and wherein the records related to at least some of the other transactions that do not affect the attributes are delayed before being stored in the change log.

9. The method of claim 8, wherein processing the transaction further comprises determining a creation time of a file associated with the transaction, wherein the record is entered in the change log when the creation time is after a time of a most recent backup.

10. The method of claim 9, wherein the record is only entered into the change log once, wherein subsequent writes to the file do not result in records being entered in the change log.

11. The method of claim 10, wherein the record denoting the creation of the file is flushed to the change log by the layered file system in a delayed manner.

12. The method of claim 11, wherein the record is flushed to the change log after a last close on the file has been detected.

13. The method of claim 8, wherein processing the transaction further comprises, when the transaction includes a truncate, or a set-attribute operation for a file, checking a creation time of the file, wherein the record is not entered for the transaction when the creation time of the file is after a time of the most recent backup.

14. The method of claim 8, wherein processing the transaction further comprises, when the transaction is appending data to a file that was present at the most recent backup, recording a last backup file size in the change log, wherein subsequent appends to the file do not result in another record in the change log.

15. The method of claim 14, wherein the backup agent backs up only a portion of the file past the last backup file size.

16. The method of claim 8, wherein processing the transaction further comprises, when the transaction corresponds to removing a file, checking the creation time of the file and if the creation time is after a time of the most recent backup, the record of the transaction is not entered into the change log as long as a record corresponding to the creation of the file is not present in the change log.

17. The method of claim 8, wherein processing the transaction further comprises, when the transaction is truncating a file, checking if a new size of the file is less than a size of the file at a time of the most recent backup, wherein the new file size is recorded in the change log when the new size is less than the older size and wherein subsequent writes past the new size do not result in a record in the change log and are treated as transactions that append data to the file.

18. The method of claim 8, wherein processing the transaction further comprises, when the transaction is a set attribute call, recording the set attribute call and an inode number and a generation number in the change log.

19. The method of claim 18, wherein a backup agent backs up the file when the file exists at the time of performing the incremental backup and the generation number matches the generation number recorded with the set attribute call.

20. A backup system configured to backup files in a file system by creating incremental backups, the backup system comprising:
a backup agent operating on a client;
a layered file system located between an operating system or a virtualized system and a physical file system; and
a change log;
wherein the layered file system is configured to:
intercept transactions that relate to files stored in the physical file system;
optimize the change log by generating records selectively for the transactions that are stored in the change log, wherein some transactions result in a record being entered in the change log and other transaction do not result in a record being entered in the change log, wherein records entered in the change log identify blocks in the physical file system that are changed by the associated transaction and wherein records are not entered in the change log for transactions that do not result in changes to the physical file system, wherein the records are configured to prevent disk accesses for files that do not need to be backed up even when changes occurred to those files and when those files are subject to the backup of the data, wherein the records include an event mask configured to represent multiple transactions for the same blocks, wherein a transaction for creating a file after a most recent backup are stored in the records and wherein transactions including writes the file created after the most recent backup are not stored in the records even if the writes result in changes to the data or the physical file system, wherein records related to transactions where only attributes of the files are affected are synchronously stored in the change log by the layered file system and wherein the records related to other transactions that do not affect the attributes are delayed before being stored in the change log; and
generate a generation number for the blocks that is included in the record associated with the blocks when the transaction is an attribute transaction that relates to an attribute or a system call;
wherein the backup agent coordinates with a backup server to perform an incremental backup of the file system from the physical file system based on records stored in the change log since a most recent incremental backup of the file system, wherein the backup agent, when a record contains the attribute transaction and the generation number, checks for an existence of the corresponding blocks at a time of the backup, wherein the blocks are backed up based on whether the generation number in the record matches the generation number of the file.
